(19) United States
(12) Patent Application Publication
(10) Pub. No.: US 2003/0144942 A1
(43) Pub. Date: Jul. 31, 2003

(54) Methods and systems for facilitating investment transactions and accounting for banks and credit unions

(76) Inventor: Michael F. Sobek, Leawood, KS (US)

Correspondence Address: John S. Beulick, Armstrong Teasdale LLP, Suite 2600, One Metropolitan Sq., St. Louis, MO, 63102, US

(21) Appl. No.: 10/354,349

(22) Filed: Jan. 30, 2003

Related U.S. Application Data
(60) Provisional application No. 60/352,960, filed on Jan. 30, 2002.

(51) Int. Cl. G06F 17/60

(52) U.S. Cl. 705/36; 705/43

(57) ABSTRACT

A method for completing an investment transaction utilizing a clearing broker network and an electronic funds transfer service gateway is described. The method comprises formatting the investment transaction into at least one of an ISO-8583 message, an XML message, a National Automated Clearing House Association (NACHA) message, and a proprietary message. The method also includes forwarding the message to a switch that accesses the electronic funds transfer service gateway, utilizing the message content to post the investment transaction to an investment services account of a consumer, transmitting an acknowledgement of the posting to the switch, and forwarding the acknowledgement to the clearing broker network.

### CROSS REFERENCE TO RELATED APPLICATIONS

This application claims the benefit of U.S. Provisional Application No. 60/352,960, filed Jan. 30, 2002.

### BACKGROUND OF THE INVENTION

This invention relates generally to banking and credit union industries, and more specifically to an investment services, settlement, and reporting system for the banking and credit union industries.

Within the scope of the banking and credit union industries, literally thousands of institutions with asset sizes ranging from a hundred thousand to hundreds of billions of dollars deliver financial services to consumers worldwide. These institutions are linked via a common hierarchy of central banks, such as the Federal Reserve, or corporate credit unions, such as the Corporate Credit Union Network, that offer quick sources of funds as a liquidity pool during times of need. These hierarchies also support the clearing and funds settlement of transactions that occur between originating and receiving financial institutions. This function can occur within a 24 hour cycle when executed by the Federal Reserve while the Corporate Credit Union Network can complete automated settlement of transactions within hours of the same day.

In a similar scope, investment service firms, on an international scale, provide advise and manage the investment accounts of individuals buying and selling securities, annuities, mutual funds, and bonds. Large scale clearing networks support the millions of electronic buy, sell, and settlement transactions that occur within the investments industry daily. Due to the millions of daily transactions that require settlement between institutions, the period of time required for a typical buy or sell transaction has been mandated to move from three days in 2001 to one day in 2003 by the Securities and Exchange Commission (SEC).

In the past, these financial banking, and securities and annuities industries offered diverse services resulting in accounts maintained in multiple, separate holding institutions causing the consumer significant effort to review their entire financial portfolio without manually merging information from several different statements or Internet banking systems into a single view. In addition, the securities and banking industries created industry-unique standards to manage their electronic transaction services with no plans for crossing between industries. Recently, the laws regulating both the banking and investment industries have been changed to enable cross industry ownership providing an opportunity for these firms to expand their marketplace and offer a suite of new, integrated financial services.

Congress enacted financial modernization legislation via the Gramm-Leach-Bliley (GLBA) Act in late 1999. The Act allows financial companies operating a bank greater latitude in the kinds of services they provide. The GLBA repealed laws established in 1933 and 1956 disallowing any overlap between the banking, securities, and insurance industries. As a result, affiliations and common management were permitted among banking, securities, and insurance firms.

The banking industry over the past several years has seen significant consolidation to increase the asset overall asset base of the merged parties resulting in increased volumes and better margin on investments achieved. The key impact to the banking industry of GLBA is the amalgamation of services through financial subsidiaries of commercial banks and financial holding companies. Financial subsidiaries are nonbanking companies engaged in financial activities, which commercial banks own but cannot directly operate in a specific field. Furthermore, financial holding companies own controlling interests in commercial banks and other financial companies such as securities and insurance underwriting corporations within their structure that are financially isolated from the banking components. In a similar light, a securities-based entity may choose to become or acquire a bank in support of its broker-dealer business. This regulatory relief has opened up opportunities for many organizations to consider crossing lines into other financial industry segments and directly compete with new products and services.

With respect to credit unions specifically, this growing but not well recognized industry currently represents over 10,000 credit unions 16, $433 billion in assets, and 80 million members across the United States. In addition, unique to the industry, credit unions invest in each other through a hierarchy of corporate credit unions that serve as pooled investment houses and primary centers of liquidity when funds are needed.

Some competitive factors of rising concern to the credit union industry are disintermediation due to the growth of broker dealers and investment companies offering mutual funds and securities with money market accounts similar to checking, growth of Internet e-commerce, Internet banking, and electronic bill pay services, and lack of relationships with the merchant and business community because of government regulations they face in offering business loans and services.

In response to these concerns, the government agency regulating credit unions, the National Credit Union Association (NCUA), has stated in its five year strategic plan “the NCUA must encourage credit unions to partner with other organizations or companies providing financial services, such as technology vendors and non-traditional financial service providers”. Due to their not-for-profit status that limits their participation in competitive business ventures, the NCUA has given credit unions 16 the rights to form for-profit companies called Credit Union Service Organizations (CUSO) with the flexibility in charter to form securities companies similar to banks, or Broker Dealers, under the guidance of the SEC and NCUA.

Given the significant competition that has appeared on the market from the securities firms who have entered the banking industry, individual banks and credit unions are aggressively seeking new services that will position their broker-dealers in a much stronger position than their competitors who already have established their market value. The securities firms have positioned themselves with products and services such as checking accounts, debit cards and loan rates that compete directly with the banks and credit unions resulting in reduced loyalty and asset losses due to disintermediation. However, banks and credit unions have typically been slow to pursue these new opportunities to deliver services outside their standard offering, and as a result, investment firms have begun to deliver banking services such as money market accounts, checking accounts, and debit card services directly competing with banks and credit unions.

### BRIEF SUMMARY OF THE INVENTION

In one aspect, a method for completing an investment transaction utilizing a clearing broker network and an electronic funds transfer service gateway is provided. The method comprises formatting the investment transaction into at least one of an ISO-8583 message, an XML message, a National Automated Clearing House Association (NACHA) message, and a proprietary message, and forwarding the message to a switch that accesses the electronic funds transfer service gateway. The method also comprises utilizing the message content to post the investment transaction to an investment services account of a consumer, transmitting an acknowledgement of the posting to the switch, and forwarding the acknowledgement to the clearing broker network.

In another aspect, a method for completing a settlement transaction in support of investment transactions utilizing a clearing broker network and at least one of a Federal Reserve banking system and a Corporate Credit Union automated settlement network is provided. The method comprises receiving an aggregation of transactions from a clearing broker network via a secure data network connection, sorting the aggregation of transactions into groups assigned to individual banks and credit unions, and totaling the transactions within the groups. The method also comprises creating posting files compatible with at least one of the Federal Reserve banking system and Corporate Credit Union automated settlement network file formats, transmitting the posting files compatible with the Federal Reserve banking system to the Federal Reserve, transferring funds equal to the total of the posting files for the Federal Reserve to an account within the Federal Reserve banking system, transmitting the posting files compatible with the Corporate Credit Union automated settlement network to the Corporate Credit Union, transferring funds equal to the total of the posting files for the Corporate Credit Union to an account within the Corporate Credit Union automated settlement network, and distributing the funds for each bank and credit union within the groups as specified within the posting files.

In still another aspect, an investment services switching, settlement, and reporting system is provided. The system comprises an investment services switching controller, a settlement gateway to at least one of a credit union settlement network and the Federal Reserve system, a clearing firm gateway to a clearing broker network, an ISO8583 network to an automatic teller machine/point of sale network, and a credit union/banking reporting/positive balance file (PBF) gateway to participating credit unions, banks, and credit union service organizations. The settlement gateway is communicatively coupled to the switching controller and the clearing firm gateway communicatively coupled to the switching controller and configured to send investment transactions to the switching controller. The ISO-8583 network is communicatively coupled to the switching controller and the PBF gateway is communicatively coupled to said switching controller. The switching controller is configured to switch transactions in real time or non-real time based upon capabilities of the participating credit unions, banks, and credit union service organizations.

### BRIEF DESCRIPTION OF THE DRAWINGS

FIG. 1 is diagram illustrating a core network of financial transaction systems.

FIG. 2 is a diagram illustrating a financial transaction system which includes a clearing broker network/electronic communication network gateway.

FIG. 3 is a diagram of an investment services switch utilized in the system of FIG. 2

FIG. 4 is a diagram of an ISOTAP Gateway switch and queuing system utilized in the system of FIG. 2

FIG. 5 is a diagram of a tiered switching network which provide the functionality of the system of FIG. 2.

FIG. 6 is a flowchart which illustrates a method for completing an investment transaction.

FIG. 7 is a flowchart which illustrates a method for completing a settlement transaction in support of investment transactions.

FIG. 8 illustrates a method for updating account balances at a credit union utilizing an account processor.

FIG. 9 illustrates a method for posting daily trades and account activity.

FIG. 10 illustrates a method for posting dividend and interest payments into credit union member investment services accounts.

FIG. 11 illustrates a method for net settlements for Credit Unions.

### DETAILED DESCRIPTION OF THE INVENTION

A variety of investment services that are offered by banking institutions and credit unions to consumers that result from the integration of banking and credit union accounting practices, systems and services, national and international settlement and electronic transaction networks, national and international securities exchanges, clearing firms, and services offered by broker dealers, securities, annuities, and bond trading firms are described below. These investment services programs are enabled by the mapping and switching of transactions that historically have not crossed business boundaries of the diverse, highly regulated, financial industries and settlement operations. Several diverse industry standards are mapped together via computer software programs and electronic switching and transaction networks to perform the necessary links between the diverse industry groups.

Transfers between financial institutions are, at least in part, handled utilizing an automatic clearinghouse network (ACH). The ACH Network is a batch processing, store-and-forward system. Transactions received by the financial institution during the day are stored and processed later in a batch mode. Rather than sending each payment separately, ACH transactions are accumulated and sorted by destination for transmission during a predetermined time period. This provides significant economies of scale. It also provides faster processing than paper checks, which must be physically handled. Instead of using paper to carry necessary transaction information, ACH transactions are transmitted electronically between financial institutions through data transmission. Typically, five participants are involved in an ACH transaction: the originating company or individual (Originator), the Originating Depository Financial Institution (ODFI), the ACH Operator, the Receiving Depository Financial Institution (RDFI), and the receiving company, employee or customer (Receiver).

The Originator is an entity that agrees to initiate ACH entries into the payment system according to an arrangement with a Receiver. The Originator is usually a company directing a transfer of funds to or from a consumer's or another company's account. In the case of a Customer Initiated Entry (CIE), the Originator may be an individual initiating funds transfer activity from his or her own account. The term “company” is intended to represent the Originator of electronic ACH entries and does not imply exclusion of other types of organizations (i.e., Federal, state and local government agencies). An Originator may be either a company or a consumer.

The Originating Depository Financial Institution (ODFI) is an institution that receives payment instructions from originators and forwards the entries to the ACH Operator. A depository financial institution (DFI) may participate in the ACH system as a Receiving Depository Financial Institution (RDFI) without acting as an ODFI. If a DFI chooses to originate ACH entries, it must also agree to act as an RDFI.

An Automated Clearing House (ACH) operator is a central clearing facility operated by a private organization or a Federal Reserve Bank (FRB) on behalf of DFIs, to or from which participating DFIs transmit or receive ACH entries. In some cases, there are two ACH operators involved in a transaction, one operating as the originating ACH operator and the other as the receiving ACH operator.

The Receiving Depository Financial Institution (RDFI) is the DFI that receives ACH entries from the ACH operator and posts the entries to the accounts of its depositors (Receivers). A receiver is a natural person or an organization which has authorized an originator to initiate an ACH entry to the Receiver's account with the RDFI. A receiver may be either a company or a consumer, depending on the type of transaction.

Funds transfer transactions completed by banks using the Federal Reserve operated ACH network require at least one day (T+1) to complete the settlement transfer of funds between institutions. However, the Credit Union equivalent of the Federal Reserve ACH system, referred to as the Automated Settlement Network, can transfer funds between Credit Unions in a matter of hours (T+0).

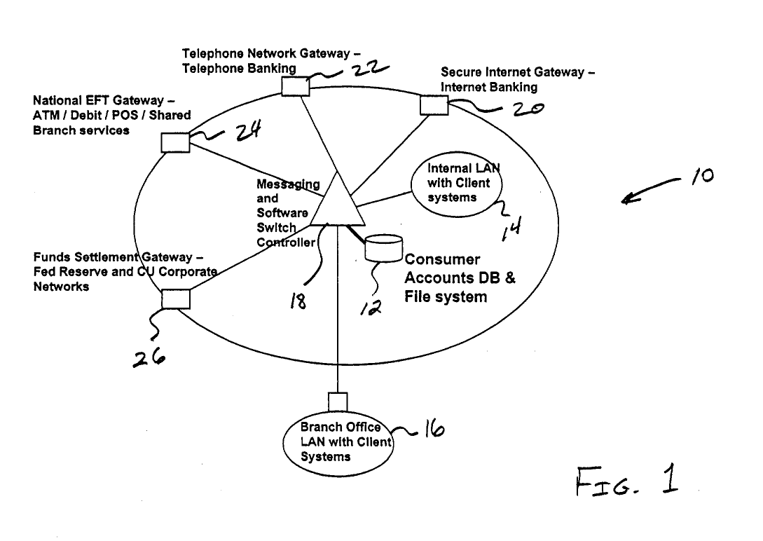

FIG. 1 illustrates a core network of financial transaction processing systems 10 typically combined to offer a suite of financial services, including funds transfer transactions, to banking customers and members of credit unions. At a center of processing system 10 is a relational database and electronic file system 12 of consumer and business accounts that contain information about every account holder associated with the bank or credit union. In one embodiment, database 12 includes name and address information, a variety of financial accounts such as checking, savings, loans, and investments such as certificate of deposit and investment retirement accounts. Database 12 typically resides on secure computer servers (not shown) with highly redundant components to maintain the integrity of the account holder files.

Database 12 is accessed by clients through file servers utilizing PC workstations 14, which are typically logically combined locally by a LAN or remotely to branch offices 16 by a WAN. Utilizing workstations 14 clients create transaction messages that initiate the primary financial services of deposit, withdrawal, account transfer, inquiry, and file maintenance for their accounts residing in database 12.

The clients transactions are routed by a software messaging and switch controller 18 that in one embodiment utilizes TCP/IP socket communications to establish logical network connections between the clients and servers to transfer data and complete core accounting functions.

Both manual and automated clients drive a variety of transactions against account holder database and file system 12. These may include electronic clients residing in gateways into the Internet 20, public telephone systems 22, national Electronic Funds Transfer (EFT) networks (ATM, Point of Sale, Debit Card, and Shared Branch) 24, and national funds settlement networks operated by the Federal Reserve and Corporate Credit Union system 26.

Each of these different gateways operate utilizing message formats that have been standardized across the industry or using proprietary formats that have been created by vendors who deliver products in support of the banking and credit union industries. Often, the gateways into the various networks described above complete a mapping of transactions into a common format that allows the primary financial services of deposit, withdrawal, account transfer, inquiry, and file maintenance to be completed seamlessly across system 10.

System 10 also provides functions such as administration and management reporting, settlement, statement generation, financial projections, interest calculations, amortization, and overall general ledger functions required to manage the bank and credit union as required by federal regulations.

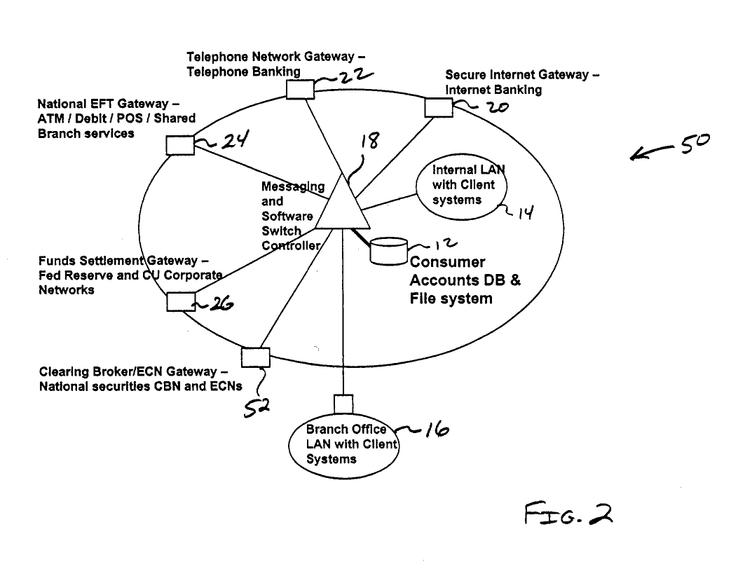

Referring to FIG. 2, due to recent changes in federal regulation and newly developed overlap in services being offered by the banking, credit union, and securities industries, the need exists for an updated financial transaction processing system. Financial transaction processing system 50 provides transaction switches and mapping gateways between a national Clearing Broker Network, Electronic Clearing Networks 52, and banks' and credit unions' core processing networks as described above with respect to FIG. 1. The addition of Clearing Broker Networks 52 into the processing system 50 provides opportunities for a variety of competitive investment services to be delivered by the banking and credit union industries.

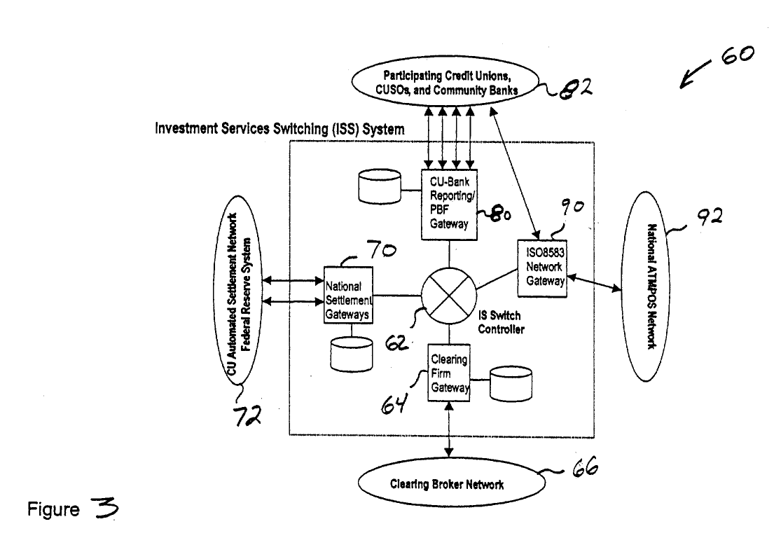

FIG. 3 illustrates an investment services switching platform 60 that allows banks and credit unions to compete with the incumbent investment companies by providing technical mapping and switching processes that enable these industries to integrate their in-house services either as single institutions, offering banking and investment services, or as multiple institutions who wish to partner and appear as a single, high volume, securities trading firm delivering a new suite of financial services to consumers. As a result of deploying the integrated investment services as provided by system 50 in FIG. 2, standard products such as integrated bank and investment statements, online live customer services, and account aggregation under a single primary checking or savings account may be offered from a single financial firm, or via a third party switching center.

Architecture of system 60 includes an investment services switch controller 62 and four key gateway interfaces that switch a variety of transactions either real time or non-real time based upon the capabilities of the participating credit union. In one embodiment, investment services switch controller 62 includes a transaction services gateway configured to map formatted transactions from a clearing broker network into NACHA transactions that will be posted against positive balance file (PBF) databases per Credit Union or mapped into ISO formatted transactions for live posting against the Credit Union member files. Transaction formats include, but are not limited to, ISO 8583, 8.2, XML, OFX/IFX, NACHA, Flat/Transaction File, and Automated Settlement proprietary formats.

Investment services switch controller 62 is also configured to write transactions to a clearing firm gateway 64 in the form of member account balance updates as per the PBF or in response to authorization requests received from clearing broker network 66. The account balance updates allow validation that funds are available in a member's investment services account to support a “buy” transaction.

Investment services switch controller 62 also incorporates a synchronization agent in one embodiment, to keeps consumer account databases within system 60 and clearing broker network common and accurate. A network management center within investment services switch controller 62 maintains running totals for the number and types of transactions passing through system 60. The network management center also polls each gateway interfaces to ensure that system 60 is fully operational both locally and remotely into deployed Credit Union ISOTAPs.

Securities clearing firm gateway 64 includes a communications interface via a dedicated IP network connection into clearing broker network 66 with peering processors residing at the clearing firms' primary brokerage accounting and cash management computers. Key files are transmitted and received through gateway 64 such as a network settlement reconciliation file, a daily available balance file, an individual dividend and interest posting file, and individual trade transactions from clearing broker network 66. Authorized ISO investment transactions routed and translated by controller 62, preprogrammed journal entries for either real time or PBF posting, and live buy/sell responses from an ISO gateway back to clearing broker network 66 are provided through clearing firm gateway 64.

A national settlement gateway 70 allows a reading of each Credit Unions database records, pulls transactions that have been aggregated over the course of a day, or less, and creates posting files that are utilized to complete settlement processes between the clearing firms and the individual Credit Union members. Gateway 70 creates transaction files that are sent to Credit Union settlement networks 72 via secure FTP for posting buy/sell or dividend transactions against individual member accounts (ISAs). Further, interfaces with federal terminals in support of Bank requirements or for Credit Unions unable to interface with the Corporate Credit Union network are provided through gateway 70.

A credit union (CU)-bank reporting/positive balance file (PBF) gateway 80 includes capability for performing critical interface functions that are utilized to map credit union or community bank investment services accounts into broker accounts maintained within clearing broker accounting systems. Gateway 80 also provides for collecting consumer account information from credit unions 82 for supporting ongoing daily account balance updates and member name and address file changes that may be transferred into all accounts maintained within the clearing broker accounting systems. Gateway 80 sends transaction files supporting ongoing daily trades, scheduled investment payments, dividend and interest payments, and commission payments as needed.

For those credit unions who are not utilizing an ISO interface, same day transaction processing meeting T+1 requirements are sent via file transfer protocol (FTP). A daily Positive Balance File (PBF) is used to post transactions against the CU members' investment services accounts. Gateway 80 further forwards daily settlement reports used for balancing between a credit union corporate settlement statement and the individual transactions posted against each member's investment services account. Gateway 80 allows generation of ad hoc reports and performance data is created and sent to credit unions 82 as needed.

An ISO 8583 network gateway 90, in one embodiment, collects daily transactions from a web interface to investment services system 60 and translates those transactions into ISO-8583 transactions for posting to members' investment services accounts.

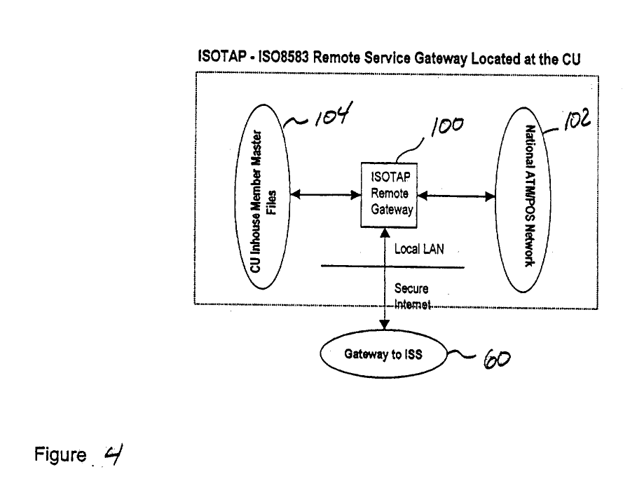

For credit unions who operate using a common national network switch, for example, E-funds, transactions are routed via an online service interface through investment services system 60. Investment services system 60 includes additional national networks 92 as more diversity is implemented for support of other credit union network backbones, for example, EDS and community bank backbones, for example, FDR. For those credit union who do not share a common electronic clearing network with investment services system 60, but conform to the ISO-8583 protocol, an optional ISOTAP switch 100 (shown in FIG. 4) may be deployed at the credit union to insert and retrieve investment transactions live from the credit union.

In one embodiment, investment services system 60 is offered via a team of participants whose roles are integrated to perform the roles of retail broker dealer, investments gateways, and clearing firm all working together to deliver the investment requested by the consumer. In another embodiment, a single entity provides all the functions associated with system 60.

For the credit union industry, as a new credit union becomes associated with investment services system 60 and acquires the approval to create a retail broker dealer CUSO, the clearing firm who is participating to offer the services becomes the clearing broker for the CUSO. Upon start up, the participating credit union creates individual Investment Services Accounts (ISA) to replace the typical securities firm's sweep and account cash management platform for the members who have accounts outside the credit unions. The CUSO licenses a broker dealer terminal for use by registered representative working for or within the credit union to capture the current market statistics and completing trades for members.

At the beginning of each trading day, investment services system 60 delivers a daily ISA balance for an account processor who maintains the brokerage accounts for the clearing firm. Individual transactions are applied to the consumer's ISA using a real-time, ISO 8583, transaction gateway or file transfer to the participating credit union who in turn posts the transactions against the master file system of the credit union. At the end of each day, investment services system 60 creates a daily net settlement file and report for each credit union to be processed via the credit union automated settlement services and the Corporate Network.

With investment services system 60 providing investment gateway services, settlement for all trades occurs either on the same day representing a T+0 settlement time, or the next day meeting the SEC requirements for T+1 settlement. The clearing firm participating in the program manages the commission calculations and investment services system 30 moves the funds as requested by the clearing firm, following the appropriate SEC regulatory requirements.

An ISOTAP Remote Services Gateway switch 100 is illustrated in FIG. 4. ISOTAP gateway 100, serves as a network device that performs a real time, ISO 8583 compliant, remote gateway into a financial institution network 102. When no investment transactions are passing through ISOTAP gateway 100, gateway 100 performs as a network bridge and all transactions between network 102 and CU member files 104 pass through the platform. Investment transactions are captured and inserted into the data stream when initiated by a consumer. ISOTAP gateway 100 is typically deployed at a Credit Union who is not sharing on a common, national electronic switching network 102, but still desires real-time posting of investment services transactions against their members' investment services accounts 104.

ISOTAP gateway 100 reads all transactions traveling between national network 102 and in house processing system 104 without disrupting the regular flow of ISO transactions. Each transaction is read and either forwarded to network 102, to processing system 104 for the Credit Union, or sent to investment services system 60 (shown in FIG. 3) for processing. When an investment service transaction is to be completed, ISOTAP gateway 60 either inserts or extracts the transaction and forwards the transaction to investment services system 60 for processing. National network 102 will not see any of the transactions forwarded or inserted by the ISOTAP gateway switch 100, thus, avoiding any disruption to the ongoing ATM, POS, Debit Card and Shared Branch transactions that are being handled by the Credit Union.

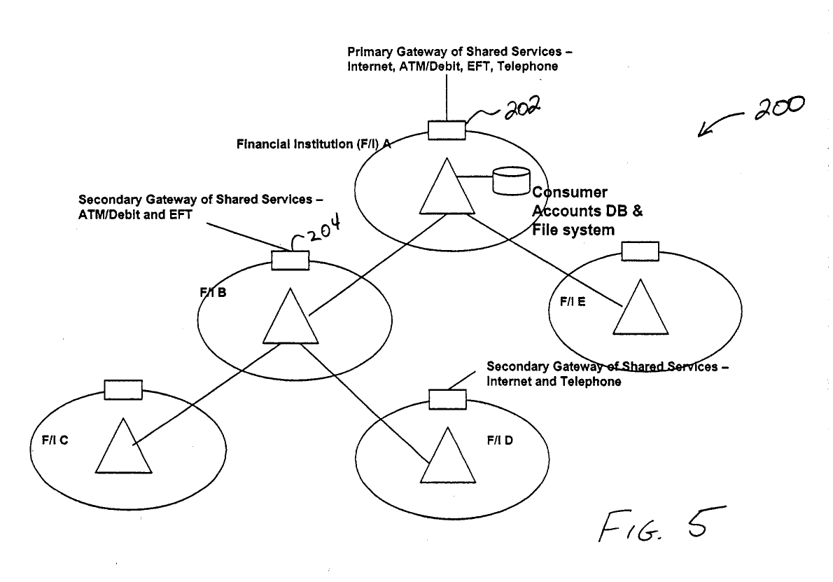

Often the cost of deploying and operating all the services that are required to compete within the banking and credit union industry are too expensive for smaller institutions to justify. As a result, an opportunity exists to deploy a geographically distributed, tiered system. FIG. 5 illustrates a geographically distributed, tiered system 200 of core switches, gateways, and ISOTAP remote switches to aggregate and share expensive service platforms such as online gateways to the National EFT networks, gateways into the public switched telephone network, or Internet banking service gateways. This tiered network supports a correspondent banking relationship between financial institutions consists of primary 202 and secondary 204 banks or credit unions that hub transactions and route them using the software switching systems to the assigned service gateway.

A routing key for the tiered network uses a 16 digit account number that includes a 6 digit bank identification number, 2 digit institution number, 2 digit branch number and 6 digit account number per account holder for the bank or credit union. The core software switches parse the 16 digit account number and route transactions to the appropriate consumer database and filing system.

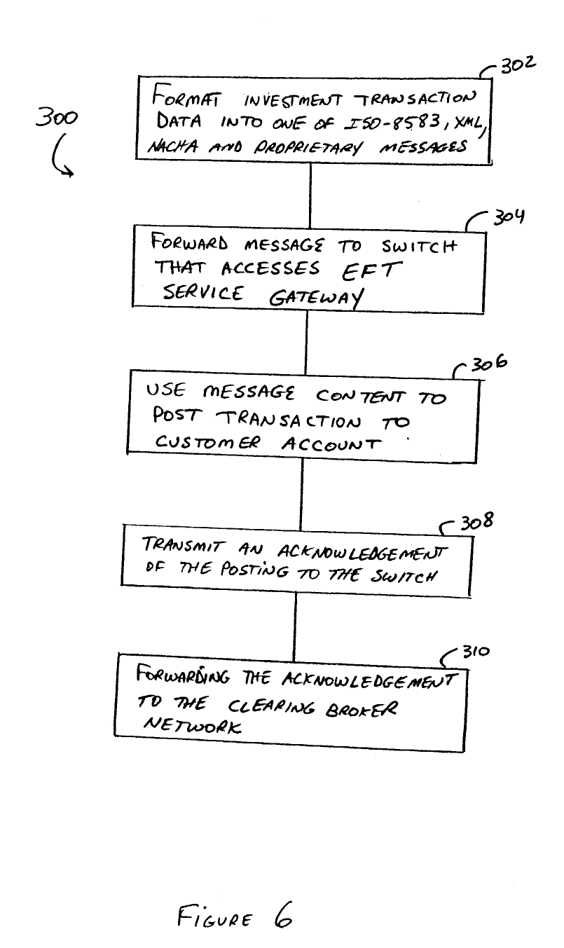

FIG. 6 is a flowchart 300 which illustrates a method for completing an investment transaction utilizing the above described systems, specifically, clearing broker network and electronic funds transfer service gateway.

Referring specifically to FIG. 6, an investment transaction is formatted 302 into at least one of an ISO-8583 message, XML message, National Automated Clearing House Association (NACHA) message, and a proprietary message. The formatted message is forwarded 304 to switch which is configured to access electronic funds transfer service gateway as above described.

Content of the formatted message is used 306 to post the investment transaction to an investment services account of a consumer and an acknowledgement of the posting is transmitted 308 to the switch. The acknowledgement is forwarded 310 to clearing broker network.

In one embodiment, formatting the investment transaction into an ISO-8583 compatible message includes mapping one or more of NACHA formatted securities transactions and Financial Information Exchange (FIX) formatted securities transactions into ISO 8583 compatible messages.

In another embodiment, and as described above, the method of flowchart 300 is facilitated by creating investment services accounts through the banks and credit unions and linking those accounts to an investment account, which includes a portfolio of securities, managed by the clearing broker. In one embodiment, the above described systems facilitate access by account holders to their investment services accounts through at least one of telephone banking, Internet banking, ATM, Point of Sale terminals, and Debit card services offered through the respective banks and credit unions. In another embodiment, the investment services accounts, including the securities linked to the accounts, are available as collateral and assets to be utilized by the account holders.

In another embodiment, the above described systems provide consolidation of periodic statements for the investment accounts held through the broker and the accounts held at the respective banks and credit unions. To provide such a consolidated statement, an aggregation of the transactions for a pre-defined period of time for the investment account are received from the clearing broker network and an aggregation of the transactions for a pre-defined period of time for the financial accounts of the account holder maintained within accounting databases and file systems managed by banks and credit unions are also received by the above described system. The received aggregations are merged into a common statement by the system and the common statement is delivered to the account holder in a paper format or as an electronic statement.

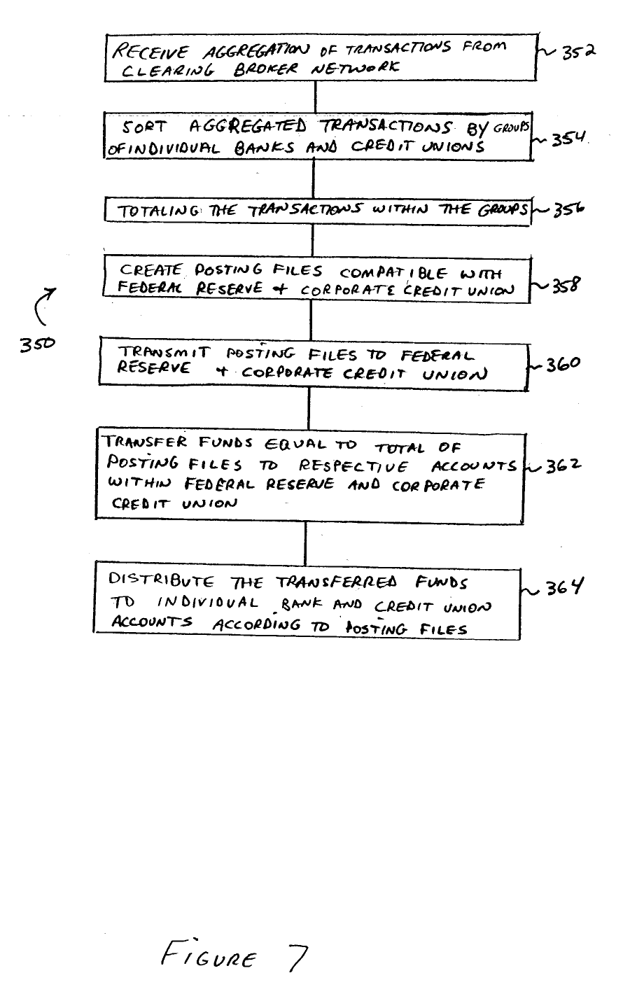

FIG. 7 is a flowchart 350 which illustrates a method for completing a settlement transaction in support of investment transactions utilizing the above described systems, including clearing broker network and at least one of Federal Reserve banking system and Corporate Credit Union automated settlement networks. Referring specifically to FIG. 7, an aggregation of transactions from clearing broker network is received 352, in one embodiment, via a secure data network connection. The aggregation of transactions is sorted 354 into groups assigned to individual banks and credit unions, and the transactions within the groups are totaled 356.

Posting files are created 358. In one embodiment, at least some of the posting files are compatible with the Federal Reserve banking system file formats and at least some of the posting files are compatible with Corporate Credit Union automated settlement network file formats. The posting files compatible with the Federal Reserve banking system are transmitted 360 to the Federal Reserve and the posting files compatible with the Corporate Credit Union automated settlement network are transmitted 360 to the Corporate Credit Union.

Funds equal to the total of the posting files for the Federal Reserve are transferred 362 to an account within the Federal Reserve banking system and funds equal to the total of the posting files for the Corporate Credit Union are transferred 362 to an account within the Corporate Credit Union automated settlement network. The funds for each individual bank and credit union within the groups as specified within the posting files are distributed 364 to the individual banks and credit unions utilizing known distribution methods.

In one embodiment, the systems above described are configured to verify a total of investment transactions for each individual bank and credit union equals the amount of funds distributed to each individual bank and credit union.

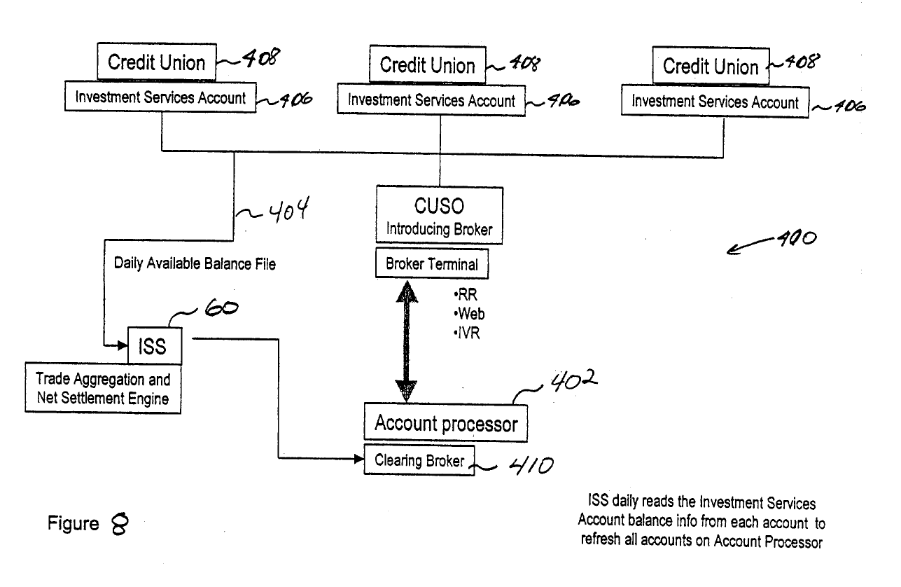

A daily account balance update method 400 is illustrated in FIG. 8. For non-real time applications, account balances between the participating credit unions and an account processor 402 are refreshed daily to ensure funds are not overdrawn in support of completing an investment. A daily available balance file 404 is run automatically and is in the exact same format as those used by the national ATM and Debit card processors, except using the investment services accounts 406 for creating the daily file. Investment service system 60 collects all of the files from participating credit unions 408, reformats the files in support of requirements of a clearing broker 410, and transmits all the files in a single transmission to account processor 402 using FTP services of investment services system 60.

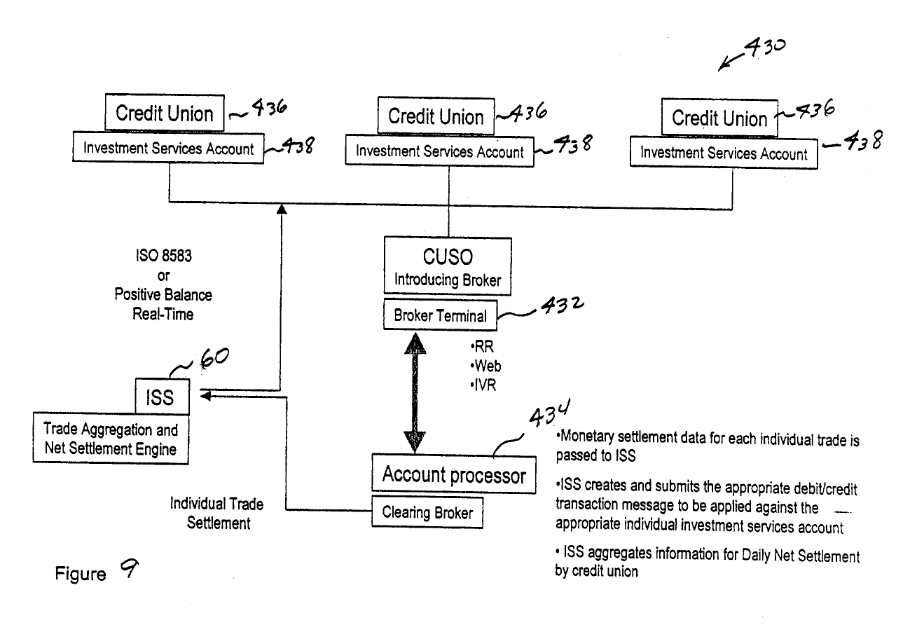

A Trade/Account activity method 430 is illustrated in FIG. 9. Trade requests to be completed are submitted to investment services system 60 as a result of a registered representative placing an order for the consumer, as a result of a call being placed to a broker 432 where a transaction is placed, or possibly via a Web site where the member initiates the transaction. The transaction is forwarded to investment services system 60 from account processor 434 and mapped to the appropriate transaction format, as listed previously, for processing either real time or non-real time. The transaction is submitted to credit unions 436 as a debit or credit to member's investment services accounts 438. At predefined daily delivery times, a daily net settlement transaction is initiated at investment services system 60 to move funds between institutions.

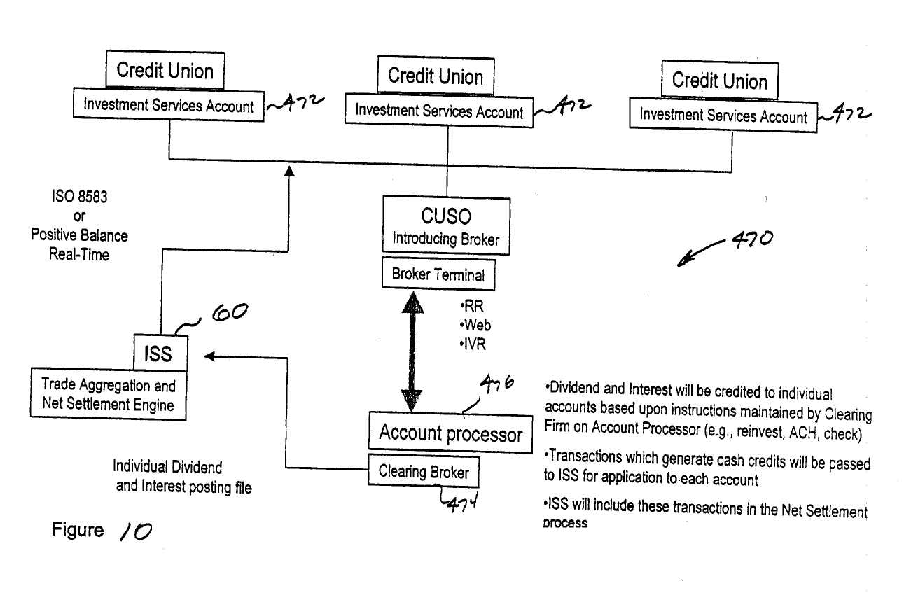

A method 470 for completing dividend and interest payments is shown in FIG. 10. Dividend and interest is credited to ISAs 472 based upon instructions maintained by a clearing broker firm 474 on account processor 476 (i.e. reinvest, ACH, check, etc). Transactions which generate cash credits are passed to investment services system 60 for application to each account 472. Investment services system 60 includes these transactions in the net settlement process.

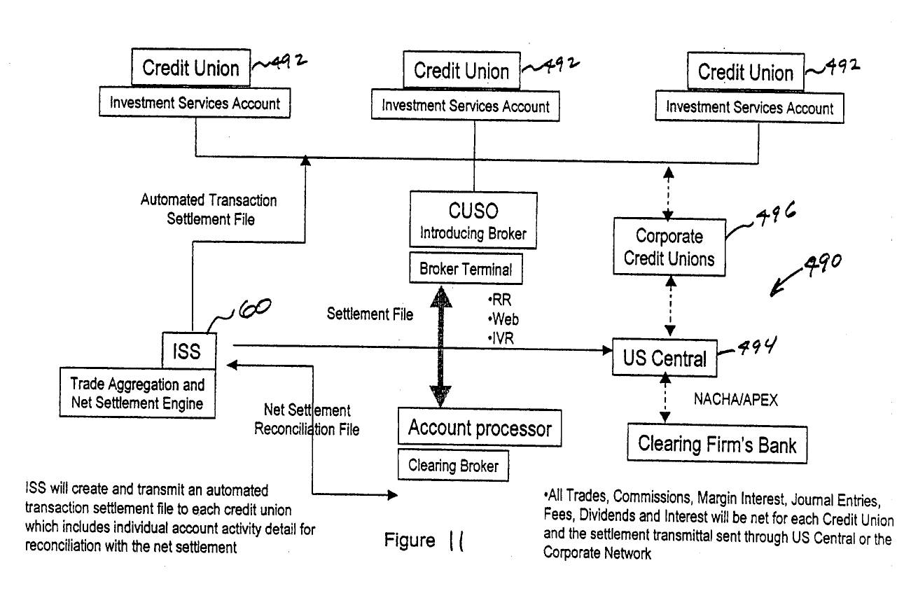

A method 490 for daily net settlement, shown in FIG. 11, is completed at a minimum of one point in time during the day; however as volume increases, more than one settlement time is often needed to meet the T+0/1 timetables. In one embodiment, investment services system 60 creates a NACHA formatted file and transmits this file to each credit union 492. This file includes individual investment service account activity detail for reconciliation with the net settlement. All trades, commissions, margin interest, journal entries, fees, dividends, and interest will be net for each credit union 492 and the settlement transmittal is sent through U.S. Central 494 or one of the Corporate Network CUs 496.

The above described methods and systems build upon existing bank and credit union accounting systems to add new services related to the delivery of investment accounts supporting the purchase and sale of securities, mutual funds, annuities and bonds. The described systems accomplish these functionalities by merging features of a proprietary, software switching and mapping system with gateways into the client server applications typical of accounting systems that deliver banking services to consumers. The result is the delivery of investment services to consumers via accounts established and maintained by banks and credit unions.

While the invention has been described in terms of various specific embodiments, those skilled in the art will recognize that the invention can be practiced with modification within the spirit and scope of the claims.

What is claimed is:

1. A method for completing an investment transaction utilizing a clearing broker network and an electronic funds transfer service gateway, said method comprising:
formatting the investment transaction into at least one of an ISO-8583 message, XML message, National Automated Clearing House Association (NACHA) message, and a proprietary message;
forwarding the message to a switch that accesses the electronic funds transfer service gateway;
utilizing the message content to post the investment transaction to an investment services account of a consumer;
transmitting an acknowledgement of the posting to the switch; and
forwarding the acknowledgement to the clearing broker network.

2. A method according to claim 1 wherein formatting the investment transaction into an ISO-8583 compatible message comprises mapping at least one of a NACHA formatted securities transaction and a Financial Information Exchange (FIX) formatted securities transaction into ISO 8583 compatible message.

3. A method according to claim 1 further comprising creating an investment services account with at least one of a bank and a credit union that is linked to an investment account, including a portfolio of securities, managed by the clearing broker.

4. A method according to claim 3 wherein the investment services account is accessible to an account holder through at least one of telephone banking, Internet banking, ATM, Point of Sale, and Debit card services offered by at least one of a bank and credit union.

5. A method according to claim 3 wherein the investment services account, including the securities linked to the account, is available as collateral and assets.

6. A method according to claim 3 further comprising:
receiving an aggregation of the transactions for a pre-defined period of time for the investment account from the clearing broker network,
receiving an aggregation of the transactions for a pre-defined period of time for the financial accounts of the account holder maintained within accounting databases and file systems managed by banks and credit unions;
merging the aggregation of transactions into a common statement; and
delivering the common statement to the account holder.

7. A method according to claim 6 wherein delivering the common statement comprises delivering at least one of a paper statement and an electronic statement.

8. A method for completing a settlement transaction in support of investment transactions utilizing a clearing broker network and at least one of a Federal Reserve banking system and a Corporate Credit Union automated settlement network, said method comprising:
receiving an aggregation of transactions from a clearing broker network via a secure data network connection;
sorting the aggregation of transactions into groups assigned to individual banks and credit unions;
totaling the transactions within the groups;
creating posting files compatible with at least one of the Federal Reserve banking system and Corporate Credit Union automated settlement network file formats;
transmitting the posting files compatible with the Federal Reserve banking system to the Federal Reserve;
transferring funds equal to the total of the posting files for the Federal Reserve to an account within the Federal Reserve banking system;
transmitting the posting files compatible with the Corporate Credit Union automated settlement network to the Corporate Credit Union;
transferring funds equal to the total of the posting files for the Corporate Credit Union to an account within the Corporate Credit Union automated settlement network; and
distributing the funds for each bank and credit union within the groups as specified within the posting files.

9. A method according to claim 8 further comprising verifying a total of the consumer investment transactions for each individual bank and credit union equals the amount of funds distributed to each individual bank and credit union.

10. An investment services switching, settlement, and reporting system, said system comprising:
an investment services switching controller;
a settlement gateway to at least one of a credit union settlement network and the Federal Reserve system, said settlement gateway communicatively coupled to said switching controller;
a clearing firm gateway to a clearing broker network, said clearing firm gateway communicatively coupled to said switching controller and configured to send investment transactions to said switching controller;
an ISO8583 network to an automatic teller machine/point of sale network, said ISO8583 network communicatively coupled to said switching controller; and
a credit union/banking reporting/positive balance file (PBF) gateway to participating credit unions, banks, and credit union service organizations, said PBF gateway communicatively coupled to said switching controller, said switching controller configured to switch transactions in real time or non-real time based upon capabilities of the participating credit unions, banks, and credit union service organizations.

11. A system according to claim 10, said switching controller configured to format the investment transaction into at least one of an ISO-8583 message, XML message, National Automated Clearing House Association (NACHA) message, and a proprietary message and forwarding the message to a switch that accesses the electronic funds transfer service gateway.

12. A system according to claim 11 wherein said settlement gateway is configured to utilize the message content to post the investment transaction to an investment services account of a consumer and transmit an acknowledgement of the posting to said switch controller.

13. A system according to claim 12 wherein said switching controller is configured to forward the acknowledgement to the clearing broker network.

14. A system according to claim 10 wherein said switching controller comprises a transaction services gateway configured to map formatted transactions from clearing broker network into NACHA transactions.

15. A system according to claim 14 wherein said switching controller is configured to post the NACHA transactions against PBF databases for each credit union, bank, and credit union service organization.

16. A system according to claim 14 wherein said switching controller is configured to map the NACHA transactions into formatted transactions for live posting against member files.

17. A system according to claim 14 wherein said switching controller is configured to support at least one of a ISO 8583, an 8.2, an XML, an OFX/IFX, a NACHA, a Flat/Transaction File, and a proprietary automated settlement transaction format.

18. A system according to claim 10 wherein said switching controller is configured to write transactions to said clearing firm gateway in the form of member account balance updates per a positive balance file.

19. A system according to claim 10 wherein said switching controller is configured to write transactions to said clearing firm gateway in response to authorization requests received from the clearing broker network, in order to validate funds are available in a individual's investment services account to support a transaction.

20. A system according to claim 10 wherein said switching controller comprises a synchronization agent configured to maintain common and accurate consumer account databases between said system and the clearing broker network.

21. A system according to claim 10 wherein said switching controller comprises a network management center configured to maintain running totals for numbers and types of transactions passing through said system.

22. A system according to claim 10 wherein said network management center is configured to poll each said gateway to ensure said system is locally and remotely operational.

23. A system according to claim 10 wherein said clearing firm gateway comprises a communications interface further comprising:
a dedicated internet protocol network connection into the clearing broker network; and
peering processors residing within primary brokerage accounting and cash management computers on the clearing broker network.

24. A system according to claim 10 wherein said clearing firm gateway is configured to transmit and receive at least one of a network settlement reconciliation file, a daily available balance file, an individual dividend and interest posting file, and individual trade transactions from the clearing broker network.

25. A system according to claim 10 wherein said clearing firm gateway is configured to transmit and receive at least one of authorized ISO investment transactions routed and translated by said switching controller, preprogrammed journal entries for either real time or PBF posting, and buy/sell responses from said ISO8583 gateway back to the clearing broker network.
